(19) United States
(12) Patent Application Publication
(10) Pub. No.: US 2014/0089060 A1
(43) Pub. Date: Mar. 27, 2014

(54) DEMONSTRATING ORGANIZATIONAL TRANSPARENCY

(71) Applicant: Clare Berty, London (GB)

(72) Inventor: Clare Berty, London (GB)

(21) Appl. No.: 14/034,258

(22) Filed: Sep. 23, 2013

Related U.S. Application Data
(60) Provisional application No. 61/704,346, filed on Sep. 21, 2012.

(51) Int. Cl. G06Q 10/06

(52) U.S. Cl. CPC G06Q 10/06393
USPC 705/7.39

(57) ABSTRACT

A method of demonstrating organizational transparency is described. The method includes: defining a plurality of different groups of readers to whom organizations may elect to make a report available, wherein each group of readers has an associated transparency value; receiving a report which has an associated group of readers; calculating a transparency level of an organization by determining the transparency value of the associated group of readers to whom the report has been made available; and publishing the calculated transparency level of the organization.

This application claims priority from U.S. provisional patent application Ser. No. 61/704,346, entitled “A Portal for Publication of Data by Organizations”, filed on Sep. 21 2012, the entirety of which is incorporated herein by reference.

### FIELD OF THE INVENTION

The invention relates to finding a way of demonstrating the extent to which an organization is transparent in its financial and other reporting. In particular, the invention is concerned with a computer-implemented method of and a system for providing and demonstrating a quantitative measure of transparency that is objectively calculated and consistent between organizations.

### BACKGROUND TO THE INVENTION

The financial world has suffered from a series of crises which has significantly reduced global confidence, both in the marketplace forming the global economy itself and in the capacity of regulators and governments to restore economic well-being.

At present very limited data about a financial institution is available in practice to the institution's management, regulators, auditors, investors, ratings agencies or the general public. What information there is tends to be at a single reporting date, out-of-date, limited in scope to a static listing of balance sheet categories, with a profit and loss account which is not dynamically related to risk. This leads to generation of snapshots of data which do not necessarily reflect the full financial picture of an institution accurately and which may not facilitate valuable comparison between institutions or contribute to quality pooling of data for macroeconomic analysis. The rules which govern the reporting of this limited data are defined by international standards, but several well-publicised issues in the banking world over a period of many years highlight the fact that too often the ever-increasing, more detailed prescription of reporting and capital requirements has resulted in the gaming of the rules by certain practitioners who do not regulate their behaviour according to the spirit of the rules. Despite the world economy having become truly global in terms of market correlation, the classic regulatory response to force ever-increasing capital requirements on struggling economies is patchy and self-defeating, resulting in regulatory arbitrage between regimes. There is unwillingness on the part of authorities to recognise, generally for political reasons, that even when carried out properly, banking is the business of managing financial risk and that all risk to the savings and deposits of small account holders can never be entirely expunged. The failures of several banks in recent times, the inability of regulators to recognise and manage potentially harmful system bubbles and the increasing public criticism of the seemingly enormous rewards of bankers have provided a backdrop whereby there is no longer any confidence in the supposed solutions of greater capital requirements (for all banks whether well-managed or not) and successively wider-ranging bailouts of banks and countries on a post-hoc basis.

Public distrust is reinforced by institutions' unwillingness to publish their financial and other information. Cultures of gaming and fear contribute to the unwillingness to publish financial information, but there are significant barriers to even the most honest and well run organizations making their financial information more widely available. Full disclosure of financial information may render even the best run institutions vulnerable to scrutiny and criticism. No organization is perfect and the perceived risk of inviting scrutiny strongly dis-incentivizes disclosure. With no clear benefits from sharing financial information, it is not surprising that institutions protect their financial information to a strong degree, thereby contributing to the circle of distrust that has become endemic.

The invention aims at addressing one or more of the various disadvantages associated with the prior art.

### SUMMARY OF THE INVENTION

The present invention stems from the realisation that reducing the barriers to organizational transparency and augmenting the benefits of publishing organizational data encourages ethical management of organizations and limits the impact of risky conduct by certain individuals in those organizations. The present invention also stems from the realisation that by promoting accountability through transparency, a virtuous circle is established whereby transparency confers an advantage to organizations when compared with less transparent or more opaque organizations. The present invention encourages organizations to be transparent about not only financial, but a wider range of other information, thereby enabling the markets to assess how well those organizations are managed.

The present invention provides a method of and a system for demonstrating organizational transparency. More specifically, according to one aspect of the present invention there is provided a method of demonstrating organizational transparency, the method including: defining a plurality of different groups of readers to whom organizations may elect to make a report available, wherein each group of readers has an associated transparency value; receiving a report which has an associated group of readers; calculating a transparency level of an organization by determining the transparency value of the associated group of readers to whom the report has been made available; and publishing the calculated transparency level of the organization.

By demonstrating organizational transparency in this way, different organizations may be compared using a quantitative, objective measure, resulting in improved market confidence in more transparent organizations and thus conferring to those organizations a market advantage. This advantage may directly benefit organizations by leading to improved positioning such as access to cheaper funding, and reducing capital and collateral requirements for lending together with the indirect benefits which accrue from greater trust in an organization which may lead to investor confidence. When investors and consumers can more positively differentiate between organizations, this may lead to higher share prices and a competitive advantage leading to greater market share. The activity of short-stalking based on inaccurate rumour would be circumvented, governments would be able to predict and circumvent asset bubbles, restoring public trust in organizations and also responding to the “shareholder spring” demand for more control over boardroom pay.

Furthermore, by virtue of creating a forum for voluntary reporting, the solution is politically neutral and inclusive, and lends suitability for global application.

In some embodiments the method may further including defining a list of topics on which organizations may voluntarily provide data for a report; and the calculating step may comprise considering how many topics from the list of topics have been reported on.

Also the calculating step may comprise reading a current transparency value for each topic and calculating the overall transparency level as an average of the current transparency values for all topics.

In some embodiments, the method may further include assigning a default transparency value to any topic of the list of topics for which a report has not been received.

According to another aspect of the present invention there is provided a system for demonstrating organizational transparency, the system comprising: a database storing a definition of a plurality of different groups of readers to whom organizations may elect to make a report available, wherein each group of readers has an associated transparency value; a transparency module for receiving a report which has an associated group of readers; the transparency module having a processor configured to calculate a transparency level of an organization by determining the transparency value of the associated group of readers to whom the report has been made available; and a server for publishing the calculated transparency level of the organization.

According to another aspect of the present invention there is provided a system for demonstrating organizational transparency, the system comprising: a processor provided within the system which is configured to: use a stored definition of a plurality of different groups of readers to whom organizations may elect to make a report available, wherein each group of readers has an associated transparency value; receive a report which has an associated group of readers; calculate a transparency level of an organization by determining the transparency value of the associated group of readers to whom the report has been made available; and publish the calculated transparency level of the organization.

According to another aspect of the present invention there is provided a computer-implemented method of demonstrating organizational transparency, the method including defining a list of topics on which organizations may voluntarily provide data for creating a report; defining a series of readerships to whom organizations may elect to make such a report available, wherein each successive readership in the series includes a further class of readers; calculating an overall transparency level of an organization by taking into account how many topics from the list have been reported on and to which readership each report has been made available; and publishing the overall transparency level of the organization. In some embodiments the method also provides further confidence in organizational data from attestation by external third party professional bodies.

In any of the above aspects of the present invention the report may be a dashboard report. This provides the advantage that multiple variables relating to a single organization may be viewed conveniently by a reader on a single page.

By defining a series of readerships in which each successive readership in the series includes a further class of readers and possible third party data attestation, a stepwise process is established for improving transparency in a series of small changes. This stepwise process facilitates improving transparency by breaking down the work required into manageable steps, and by creating recognition for the completion of any one of those steps. Furthermore, the stepwise process enables engagement in the process of becoming more transparent to be positively recognised even in the early stages when transparency is initially more limited.

### BRIEF DESCRIPTION OF THE DRAWINGS

Specific embodiments of the invention will now be described, by way of example, with reference to the accompanying drawings, of which:

FIG. 1 is a schematic block diagram showing a system for implementing an embodiment of the invention, including an exchange system, an exchange database, and a communications network connecting the exchange system to various parties interacting with it;

FIG. 2 is a schematic block diagram showing further detail of the exchange system and exchange database of FIG. 1, including a processing module of the exchange system;

FIG. 3 is a schematic block diagram of the processing module of the exchange system of FIG. 1;

FIG. 4 is a schematic block diagram of the exchange database of FIG. 1;

FIG. 5 is a schematic block diagram showing information flow between elements of the system of FIG. 1;

FIG. 6 is a look-up table indicating readership definitions and corresponding numerical transparency values according to the embodiment of FIG. 1;

FIG. 7 is a flow chart showing a method of sharing a dashboard report according to the embodiment of FIG. 1;

FIG. 8 is a flow chart showing a method of providing accountability for misreporting according to the embodiment of FIG. 1;

FIG. 9 is a set of four screenshots showing webpages delivered by the system of FIG. 1 to a reader for navigating through a graphical user interface to locate information on a particular organization;

FIG. 10 is a fifth screenshot showing a webpage delivered by the system of FIG. 1 to a reader displaying categories of information relating to a located organization;

FIG. 11 is a sixth screenshot showing a webpage delivered by the system of FIG. 1 to a reader displaying sub-categories of information relating to the located organization;

FIG. 11a is a seventh screenshot of a webpage showing a pop-box displaying additional information to a reader to provide help improve understanding of the financial system;

FIG. 12 is a set of a further four screenshots showing webpages delivered by the system of FIG. 1 to a reader displaying various aspects of the functionality of the graphical user interface;

FIG. 13 is a twelfth screenshot showing various explanations of the system of FIG. 1, including a display of the readership definitions and corresponding numerical transparency values mentioned above in relation to FIG. 6;

FIG. 14 is a thirteenth screenshot including the display of readership definitions together with further explanatory notes;

FIG. 15 is a fourteenth screenshot of a webpage enabling a reader to stress test organizational data by using sliders to ask ‘what if’ questions of the data to establish likely outcomes for the organization economic conditions change in certain ways;

FIG. 16 is a fifteenth screenshot of Compliance and Reporting Status which enables the reader to assess the regulatory regime under which the organization operates;

FIG. 17 is a sixteenth screenshot of Corporate and Individual Conduct Risk Management which describes risks associated with customers and products;

FIG. 18 is a seventeenth screenshot of Early Alerter status and handling of whistleblowing issues within the organization;

FIG. 19 is a eighteenth screenshot of Fine and Cost Status assesses the outcomes of actions by regulators against the organization;

FIG. 20 is a nineteenth screenshot of Individual Conduct Risk Management and relates to the assessment of the economic impact of inappropriate behaviours by certain individuals;

FIG. 21 is a twentieth screenshot of Investigation Status relating to ongoing regulatory investigations; and

FIG. 22 is a twenty-first screenshot of Mis-selling and Breach Status which assesses particular regulatory actions in respect of products and customers of the organization.

Throughout the figures, like reference numerals are used to denote like features.

### DETAILED DESCRIPTION OF PREFERRED EMBODIMENTS

Although several embodiments, examples and illustrations are disclosed below, it will be understood by those of ordinary skill in the art that the invention described herein extends beyond the specifically disclosed embodiments, examples and illustrations and includes other uses of the invention and obvious modifications and equivalents thereof. Embodiments of the invention are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention. In addition, embodiments of the invention can comprise several novel features and no single feature is solely responsible for its desirable attributes or is essential to practicing the inventions herein described.

The terms “computer,” “terminal,” “computing system,” “computer clients,” “servers,” or “computing system devices,” as used herein are interchangeable terms, and the terms broadly refer, without limitation, to a machine that manipulates data according to a list of instructions, combinations of the same, or the like.

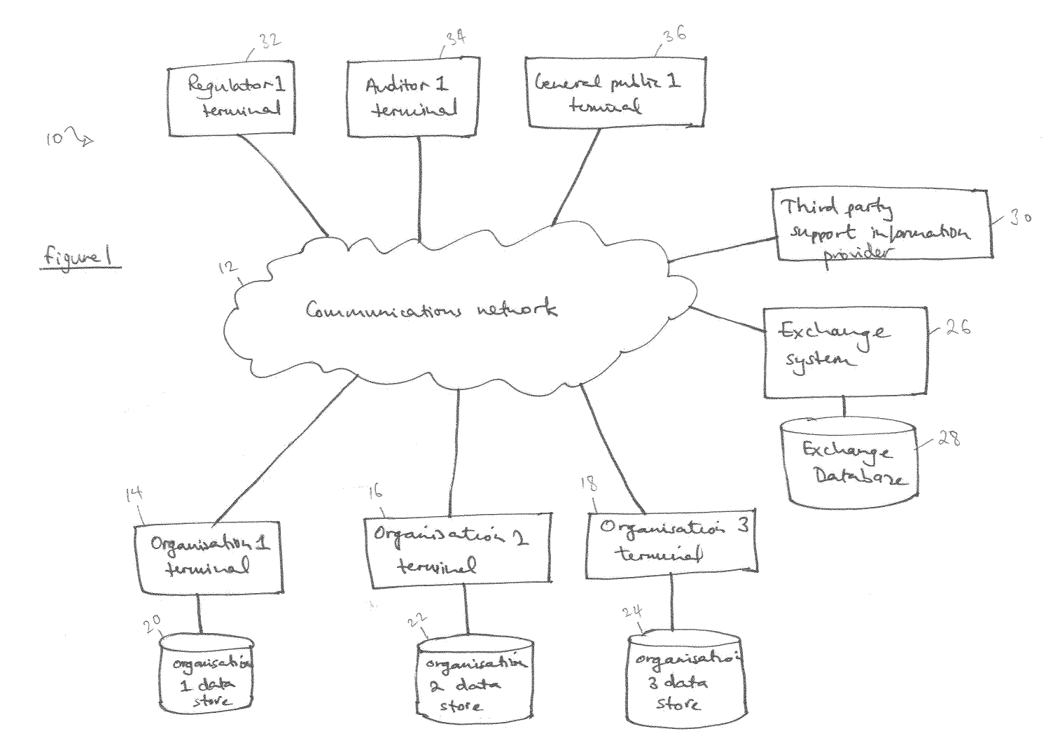

An information sharing system for implementing an embodiment of the invention is shown in FIG. 1. The system 10 includes a communications network 12, for example a wide-area network such as the Internet, which connects various parties involved in the implementation of the invention and provides network infrastructure for both the sharing and accessing of data. Terminals 14, 16, 18 of various organizations wishing to share information which also form part of the system 10 are connected to the communications network 12 in order to upload selected data for sharing with target readers. Each organization terminal 14, 16, 18 is connected to a respective organization data store 20, 22, 24 which stores a wide range of data relating to the respective organization.

Data provided by participating organizations may be uploaded via the communications network 12 to a centralized hub, or exchange system 2, where it can be managed and processed by the exchange system 26. The exchange system 26 is also connected to the communications network 12 and may receive data sent via the communications network and provide processed or other data to other parties (readers) via the communications network 12. Any data that is processed or received by the exchange system 26, or data that is of use for the operation of the exchange system 26, may be stored in the exchange database 28 which is operatively connected to the exchange system 26. As a composite unit, the exchange system 26 and the exchange database 28 represent the core infrastructure of the embodiment and it is here that the principle management and control of the information which has been shared by the various organizations takes place.

Some information for provision to readers is sourced from parties other than organizations wishing to share their data. For example, a third party support information provider 30, such as Wikipedia®, may be used to supplement or enhance the sharing of information by overlaying definitions or explanations of terms used, in order to enhance the intelligibility of the shared information and thereby improve accessibility of the data to wider groups of readers. The third party support information provider 30, realised as a webserver, for example, is connected to the communications network 12 so that the exchange system 26 may access definitions and other information from the third party support information provider 30, for incorporation into data which is presented to readers.

Finally, the system 10 includes terminals of a range of readers are connected to the communications network 12. There are various different types of readers and who can access shared information, and they have various relationships to the organizations wishing to share data. For example, as shown in FIG. 1, a regulator terminal 32 is connected to the communications network 12, as are an auditor terminal 34 and a general public terminal 36. The varying roles and nature of the different readers is reflected in different extents to which participating organizations may elect to share their information, as will be discussed in further detail below.

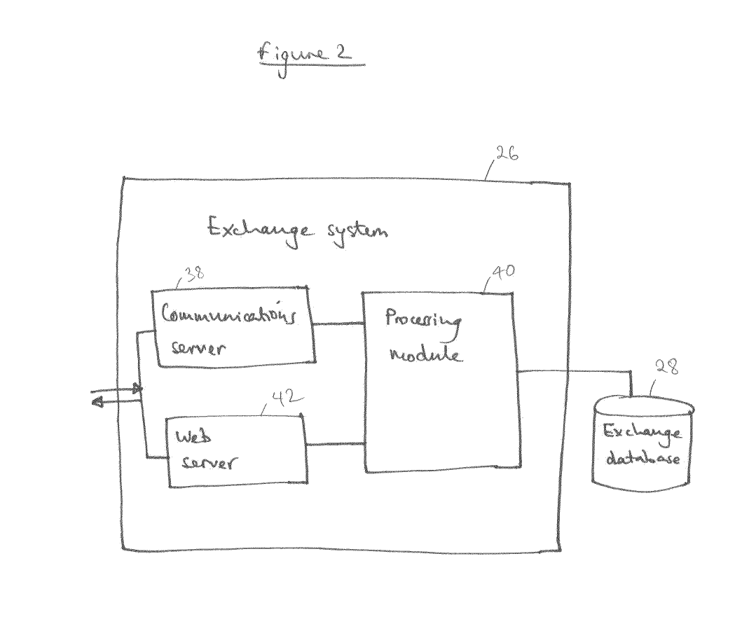

With reference to FIG. 2, the exchange system 26 has various internal structures for processing and communicating data. A communications server 38 is arranged for receiving data such as data uploaded by organizations wishing to share their information and data sourced from the third party support information provider 30. The communications server is also arranged for sending and receiving other communications, for example communications required for delivering secure log-in details to readers or communications involved in the process of receiving alerts from whistle-blowers alleging that a participating organization has provided mis-information.

The communications server 38 is operatively connected to a processing module 40 which processes and manages information received by the exchange system 26. The processing module 40 is operatively connected to the exchange database 28 so that information received by the processing module, processed or adapted by the processing module or required by the processing module for its operation may be stored in the exchange database 28 and accessed directly by the processing module 40. The processing module is responsible for various processing procedures applied to information shared by participating organizations, and produces various outputs including data for the provision of web pages to readers. This data is served to readers by a web server 42 of the exchange system 26 which is connected to the processing module 40 and delivers web pages to browsers (not shown) of regulator, auditor, general public and other terminals 32, 34 36 via the communications network 12.

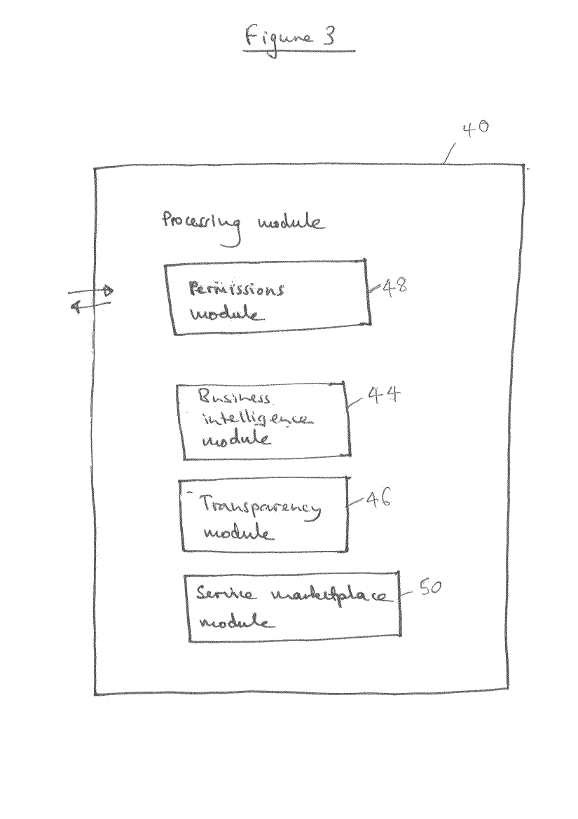

The principle functions of the processing module 40 are reflected in its own internal modules, as shown in FIG. 3. The processing module has a business intelligence module 44 which runs business intelligence programmes for generating reports from business data. In this embodiment the reports are dashboard reports. A dashboard report is a presentation of more than one variable relating to an organization on a single page. The dashboard report may include standardized reporting metrics (as perhaps required for regulatory reporting purposes) as well as customised metrics created by more sophisticated analysis. The business intelligence module 44 is arranged to allow organizations wishing to share their data to upload data via their terminals 14, 16, 18 in various formats. The business intelligence module 44 then generates a dashboard report for sharing with the appropriate readers from that basic data. Alternatively, an organization may wish to upload the data directly into a dashboard report without providing underlying business data. In either case, the originally provided data set does not have to be shared with readers directly; rather a dashboard report is generated and readers are provided with access to the dashboard report for gaining an understanding of the meaning and significance of the underlying data. Participating organizations may share data relating to a range of topics and for each topic, either data is uploaded directly or the business intelligence module 44 is arranged to generate a topic-specific dashboard report. There is a wide-ranging, predefined list of topics on which organizations may provide data for reporting. These include financial topics such as capital and liquidity, but also extend to sharing information on other aspects of an organization such as risk, compliance, various human resources matters, environmental impact and other topics of interest. The business intelligence module 44 generates dashboard reports on a variety of topics. These dashboard reports use standard algorithms and metric generation which will be well known to the skilled person. Accordingly, the way in which these dashboard reports are generated is not described herein.

As mentioned above, the system 10 is arranged so that organizations may choose which readers will be able to gain access to dashboard reports generated from their uploaded data. The present embodiment involves a pre-defined hierarchy of groups of readers, and for each topic participating organizations may select a level in the hierarchy depending on which groups of readers they wish to share their dashboard report with for that topic. By pre-defining the hierarchy of readers in this way, although the general public may not have direct access to the data, they will gain confidence in the organization from the fact that a given group of readers has access to the data, for example the full Board of Directors. In the case of the next level, the data is made available and attested or independently validated by a selected external assurer. At the next level, the data is attested or independently verified by the organization's own external auditor but is also available to be viewed by their own external regulator(s).

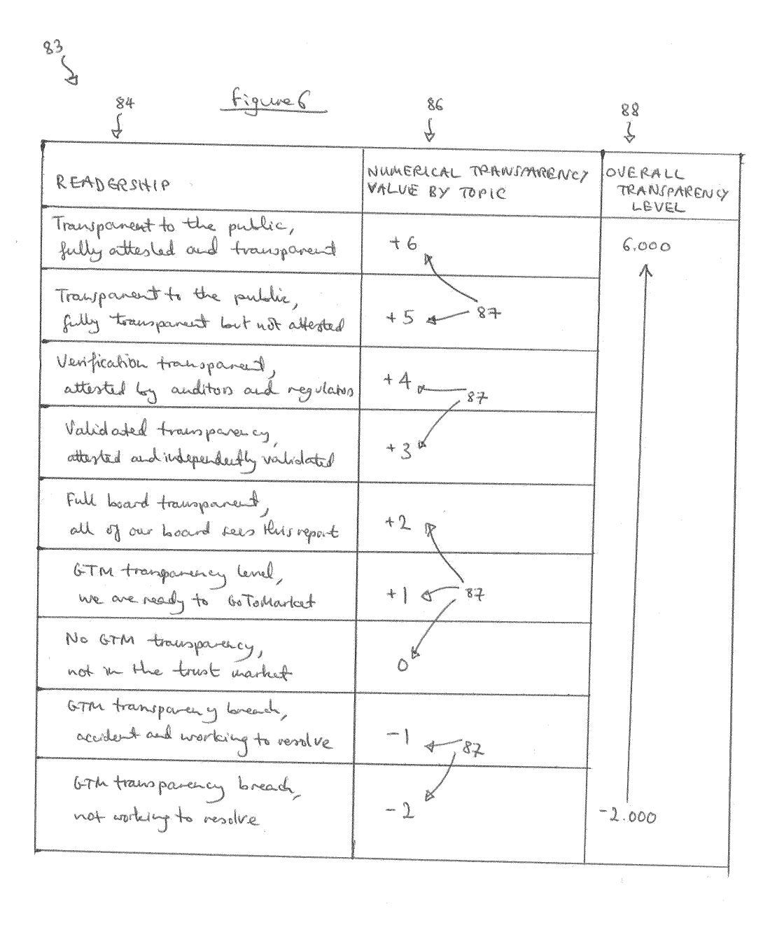

This means that organizations can control how transparent they are for each topic. The greater the number of types of readers an organization extends access to, the more transparent the organization is for that topic. Even where data is not available for the general public to view, they may gain confidence from the fact that successively the Board of Directors have access to the data, or external assurers or external auditors have attested the data and that external regulators have the data available to them. As will be described further below with reference to FIG. 6, a measure of transparency (a transparency metric) is provided by assigning a numerical transparency value for successive levels in the hierarchy of groups of readers. A more transparent dashboard report, accessible by more types of readers, including external attestation of the data at certain levels, results in the organization being assigned a transparency metric with a higher numerical transparency value for that topic.

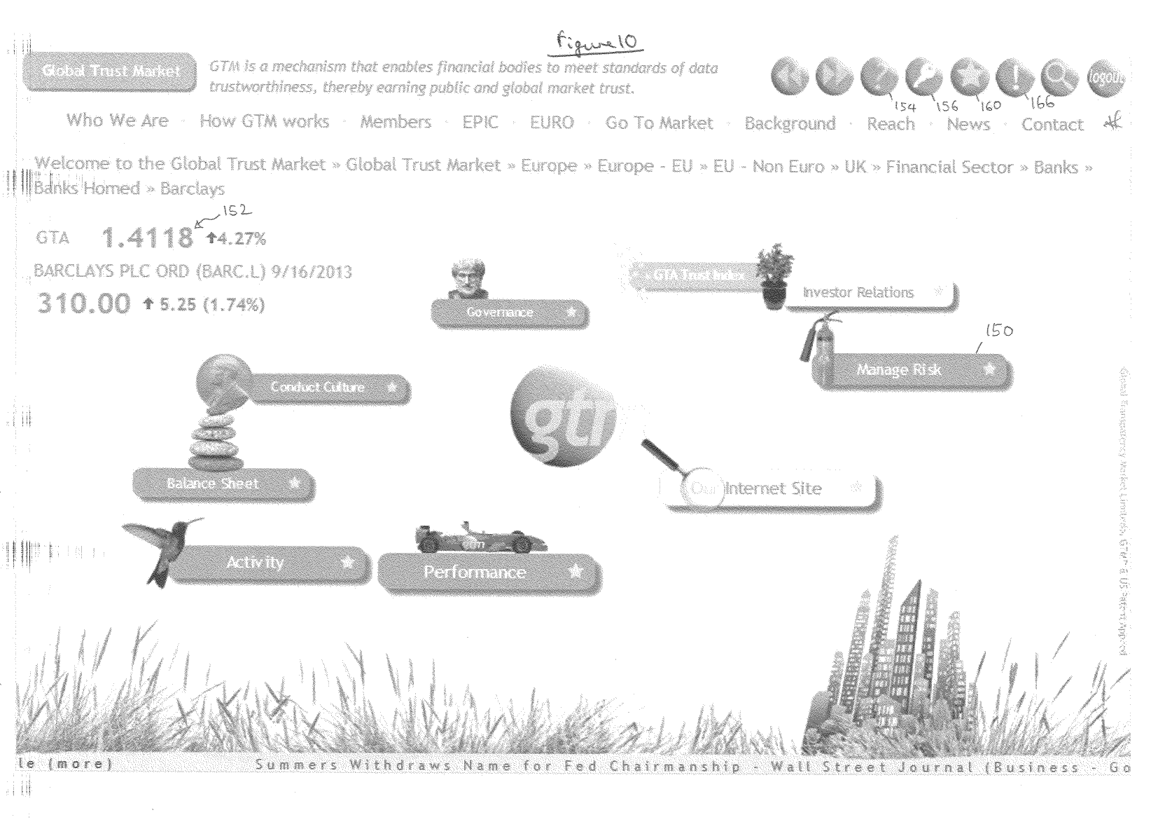

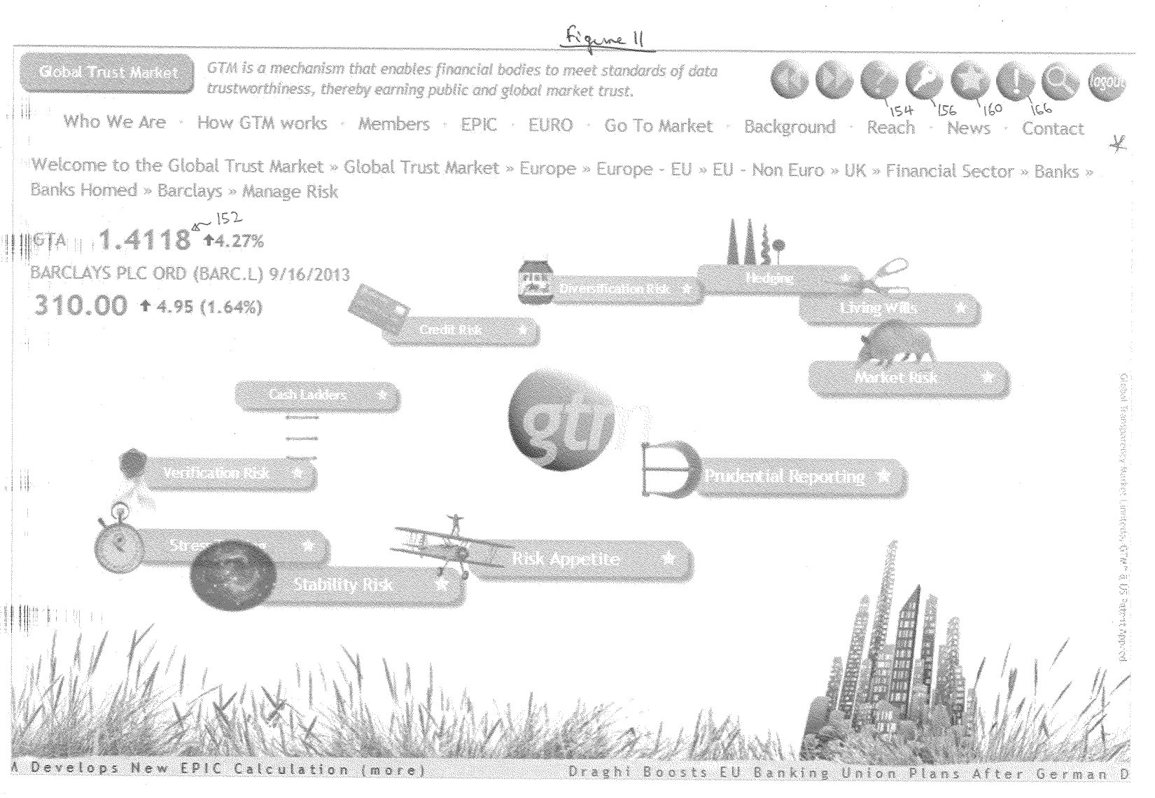

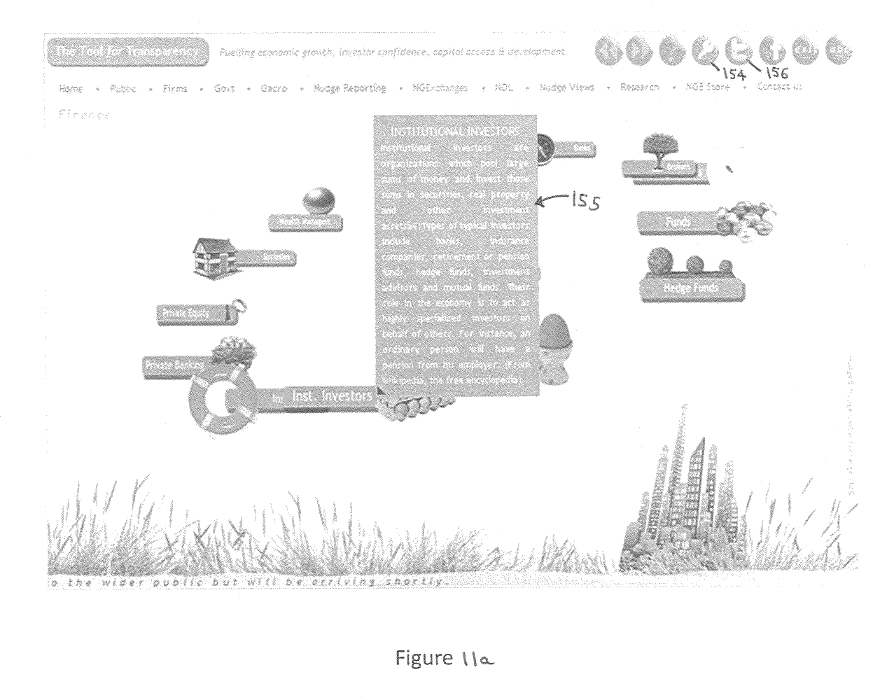

Referring back to FIG. 3, the processing module 40 also includes a transparency module 46 which provides an overview of the extent to which an organization is transparent with its information. The transparency module 46 also manages the attestation process by checking the validity of the attestation of each dashboard report either by the auditor that the full Board of Directors has access to the dashboard report or the confirmations by either the external assurers or auditors that they have independently verified the contents of the data in the dashboard report. As will be described further below, the transparency module 46 takes as an input the various numerical transparency values associated with an organization by topic, and processes these values to calculate an overall transparency level (152—shown in FIGS. 10 and 11 described later) which represents the transparency metric of the organization as a whole. The calculation is objective and based on voluntary sharing of information by organizations.

In order to ensure that only the readers chosen by participating organizations can access specific dashboard reports, the processing module 40 also includes a permissions module 48 for managing permissions. This module 48 controls the accessing of specific dashboard reports by readers by assigning secure log-in details to permitted readers and by checking the validity of log-in details entered by readers requesting access to dashboard reports. The processing module 40 also includes a service marketplace module 50 which brings together providers and consumers of specific services such as financial modelling services. The service marketplace module 50 will be described further below.

As will be appreciated, the exchange system 26 and exchange database 28 serve to manage the flow, processing and accessing of information relating to various topics provided voluntarily by organizations wishing to share their data. However, the system 10 relates not only to organizations wishing to share their data, but also to organizations who are silent in terms of voluntary reporting, and in this way the present embodiment enables direct comparison between participating organizations who are actively sharing their information via uploading to the exchange system 26 and silent organizations who are not engaged in the process of voluntary reporting. This ability to compare all types of organizations, whether engaged or not engaged with voluntary reporting, is enabled by the provision of a comprehensive directory of organizations 51 stored in the exchange database 28, which stores information regarding organizations regardless of whether they upload their data to the exchange system 26.

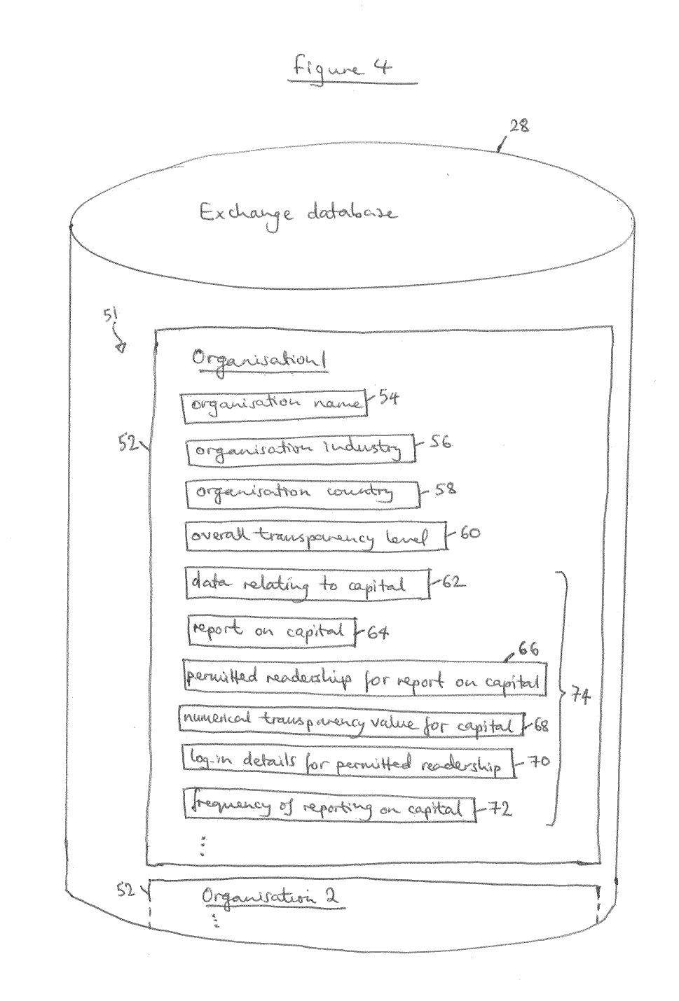

As shown in FIG. 4, the directory of organizations 51 includes an entry or profile 52 for each listed organization comprising a plurality of pre-determined data fields. Some of these data fields are common to both unengaged and engaged organizations whilst others arise, or are populated, as a result of information-sharing (engagement). For example, some basic data fields such as an organization name field 54, an organization industry field 56, and an organization country field 58 are populated for all listed organizations. Another data field that is always populated is the overall transparency level data field 60, the overall transparency metric. This data field is always populated because, as will be described further below, the transparency module 46 calculates an overall transparency value 152 for the organization and updates this data field 60 even if the organization is not engaged with the process of transparent reporting.

By contrast, some data fields are only populated, or only arise, when an organization engages in the process of transparency by sharing their information on at least one topic. For example, still with reference to FIG. 4, if an organization uploads data relating to their capital for creating a dashboard report on capital, the profile 52 of that organization will include data relating to capital 62 and a dashboard report on capital 64 which has been generated by the business intelligence module 44. Alternatively, the organization may choose to upload data directly to the dashboard report without providing underlying data. The organization can select a permitted readership 66 for that dashboard report, and this will also appear in the profile 52 together with a corresponding transparency metric having a numerical transparency value for the topic of capital 68 (described further below in relation to FIG. 6). Secure log-in details 70, such as a username and password, for the permitted readership will also be stored in the profile 52. A frequency of reporting on capital data field 72 indicates how frequently the organization provides data relating to capital. As a whole, the set 74 of data fields 62, 64, 66, 68, 70 and 72, which are specific to the topic of capital, is repeated in the profile 52 for every other topic on which the organization has uploaded data.

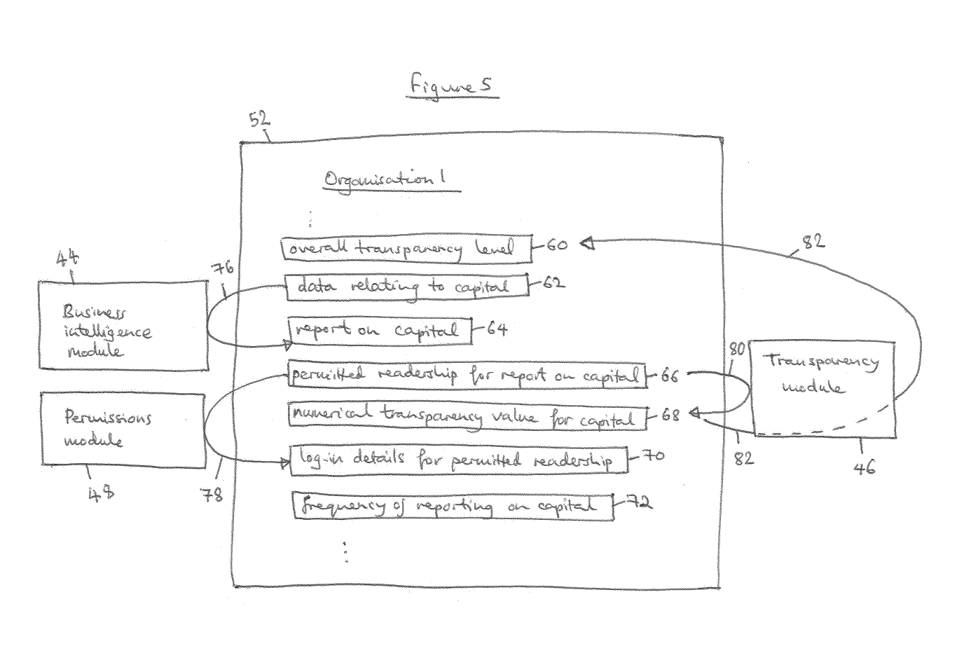

As will be appreciated, some of the data fields, such as the organization name field 54 and the organization industry field 56, in the profile 52 of an organization are stored simply in the form in which they were uploaded (typically as text fields), without having been processed in any special way. Other data stored in the profile 52 is the result of a processing step carried out by one of the sub-modules of the processing module 40, and as a result there is a clear relationship between certain data fields in the profile 52 of an organization and the specific modules within the processing module 40 of the exchange system 26. This relationship, and the corresponding flow of information between the exchange database 28 and the processing module 40 is represented diagrammatically in FIG. 5 by a series of arrows between data fields and elements of the processing module 40.

Referring to FIG. 5, uploaded organizational data relating to capital 62 is read and processed by the business intelligence module 44 which generates a dashboard report on capital 64 (or the data for the dashboard report is simply uploaded directly without underlying data) which is then stored in the exchange database 28 as part of the relevant profile 52. In this pattern, which exists for all topics, information flows as indicated by arrow 76 from the uploaded data stored in the exchange database 28, either through the business intelligence module 44 of the processing module 40, or directly, and back into the exchange database 28 in the form of a dashboard report 64. Similarly, once the organization has chosen who is permitted to read the dashboard report and communicated this to the exchange system 26 to populate the relevant profile 52, the permitted readership field 66 is read and processed by the permissions module 48 which generates secure log-in details which are then stored in the exchange database 28 in the log-in details field 70. As a result, information flows as indicated by arrow 78 from the permitted readership field 66 stored in the exchange database 28 to the permissions module 48 and back into the exchange database 28 in the form of security data 70.

The permitted readership field 66 is also read by the transparency module 46. The transparency module 46 reads the permitted readership field 66 stored in the exchange database 28 and by reference to a look-up table 83 (which will be described below with reference to FIG. 6), determines a corresponding numerical transparency value for the topic of ‘capital’. The numerical transparency value for capital is then stored in the exchange database 28 in the numerical transparency value field 68. The flow of information, which again exists for all topics, is represented by arrow 80 starting at the permitted readership field 66, travelling via the transparency module 46, and returning to the profile 52 at the numerical transparency value field 68. However, the transparency module 46 carries out a further process of reading the numerical transparency value field 68, together with the numerical transparency value fields of all topics for that organization, and calculating an overall transparency level 152 for the organization which is then saved in the profile 52 in the overall transparency level data filed 60. This reading and writing process is indicated by arrow 82 in FIG. 5. This functionality of the transparency module 46, and the meaning of the calculation in terms of readerships and the nature of the transparency of the organization, will be described below with reference to FIG. 6 and various of the subsequent flow charts.

In the present embodiment, the concept of transparency is associated with a pre-defined set of entities with which organizations can choose to share each of their dashboard reports 64. This means that when an organization wishes to share a dashboard report 64 with specific types of readers (a readership), it is presented with fixed options of how to share the dashboard report 64. The pre-defined readerships are arranged into a hierarchy of increasing size, creating a scale of readerships of increasing breadth with whom dashboard reports can be shared but more importantly the hierarchy corresponds to increasing levels of confidence which may be gained from a dashboard report given the additional attestation (external verification of the data) at successive levels. Each successive readership in the series includes a further class of readers compared with the one before with a corresponding increase in the external verification of the organization's data which leads to extra confidence and trust in the data. As a result, the series of readerships corresponds on a one-to-one basis with a scale of associated numerical transparency values. This is in effect numbering the readerships in order of increasing breadth and perceived reliability.

Based on this scale of numerical transparency values, organizations can be allocated an appropriate numerical transparency value for a particular topic depending on who it shares its dashboard report for that topic with. Therefore, if there are 100 topics in the predetermined list of topics, each organization is allocated 100 numerical transparency values, each providing an indication of how transparent the organization is in relation to that topic.

In order to allocate a particular numerical transparency value to a specific topic, the transparency module 46 takes as an input the permitted readership 66 stored in the exchange database 28 and converts it into the corresponding numerical transparency value by referring to the look-up table 83 shown in FIG. 6.

Referring to FIG. 6, a first column 84 indicates the various permitted readerships from which an organization can choose for each dashboard report. A second column 86 shows nine corresponding numerical transparency values 87 ranging from ‘−2’ to ‘+6’. Numerical transparency values in the range ‘+2’ to ‘+6’ correspond to active engagement with the process of transparency by uploading data for reporting on a particular topic and selecting a particular readership. The numerical transparency value ‘+1’ is an entry level and all organizations are assigned a default numerical transparency value of ‘+1’ for all topics for an initial grace period of, for example, 6 months. After the expiry of the grace period the value reverts to ‘0’ for all topics on which an organization has not provided any data for reporting. The negative numerical transparency values represent a breach of transparency by way of incorrect information having been reported.

With active engagement having numerical transparency values of ‘+2’ to ‘+6’, the numerical transparency value of ‘+2’ indicates that a dashboard report for a topic has been shared with a full board of the organization. This means that all members of the board will see the dashboard report, including any non-executive directors, rather than for example only a very select sub-group of the board which may be influenced by the opinion of a manipulative or otherwise coercive chief executive. In this way, full board membership helps to support the health of the board by enabling transparency across the full board.

The numerical transparency values ‘+3’ and ‘+4’ indicate sharing a dashboard report with a party external to the organization so that the external party can attest to the accuracy of the dashboard report. The numerical transparency value of ‘+3’ can be achieved by having the dashboard report attested by any external organization, whilst numerical transparency value of ‘+4’ indicates that the dashboard report has been attested specifically by the organization's auditor 34 and is made available to and viewed by the organization's regulator 32. Attestation by the auditor and availability to the regulator inherently confers a more rigorous level of attesting because the auditor and regulator are typically familiar with the structure and details of the organization. By contrast, an alternative external attester may be less familiar with the organization as a whole.

The numerical transparency values of ‘+5’ and ‘+6’ indicate that a dashboard report has been shared with the general public. The numerical transparency value of ‘+5’ can be achieved simply by allowing the public to access the dashboard report, and no attesting by an external party is required. This is useful for organizations wishing to put their dashboard report in the public domain for a high level of transparency, but whose budget does not allow hiring an external party to independently attest the dashboard report. Finally, the numerical transparency value of ‘+6’ is a gold (optimum) standard for transparent reporting and indicates that a dashboard report has been shared with the general public, and has also been attested by the organization's auditor 34 and is viewed by the organization's regulator 32.

Within the negative levels, the numerical transparency value ‘−1’ indicates that incorrect reporting has taken place and that this was accidental and that the organization is working to resolve the inaccuracy. Incorrect reporting is thus penalised even if it is accidental. However, there is a distinction drawn between accidental inaccuracies in reporting and inaccuracies which the organization is not working to resolve. A breach which the organization is not working to resolve, and which may have been intentional in some way, or is actively seeking to mislead or conceal (making it an altogether more serious breach), is associated with a numerical transparency value of ‘−2’.

The hierarchy of readerships and the scale of numerical transparency values create a stepwise process for progressing towards a high level of transparency for every topic. Organizations may engage with the process at any level for a given topic with the ultimate goal of progressing towards full transparency at a numerical transparency value of ‘+6’ for all topics. Alternatively, an organization may choose not to progress beyond level ‘+4’, and simply gain the extra confidence from the markets available at that level.

The system 10 provides a mechanism for demonstrating the overall extent to which an organization is engaged with the process of transparent reporting across all topics. This mechanism is by way of a calculation performed by the transparency module 46 in the processing module 40 of the exchange system 26, and generates an overall transparency level 152 of the organization.

In the present embodiment, the overall transparency level 152 is calculated by taking an average of all the individual numerical transparency values of the topics, and is given to four decimal places. Therefore the overall transparency level 152 of an organization may take a value between −2.0000 and +6.0000. This numerical range is graphically represented in FIG. 6 by a third column 88 appended to the look-up table 83. For the avoidance of doubt, the third column 88 does not form part of the look-up table 83 of FIG. 6.

As will be appreciated, the allocation of a numerical transparency value of zero to an absence of reporting serves to influence the value of the overall transparency level to enable the overall transparency level to take account of non-reporting. This objective may be achieved in other embodiments by taking an average of the numerical transparency values for topics which have been reported on, and then separately establishing the number of topics that have not been reported on and weighting the average based on that number.

Furthermore, the negative values provide punitive scoring which helps to make organizations accountable for misreporting. They also give recognition to organizations who have accidentally misreported and but are working to resolve the situation by distinguishing them from those who are not seeking a solution and who may have misreported intentionally. However, other embodiments of the invention are envisaged in which punitive scoring is not provided, and in which organizations may be made accountable for misreporting by other means, for example publication of a warning icon or other public indication of the misreporting if the misreporting does not affect an overall transparency level 152 in other embodiments.

The service marketplace module 50 provides a range of different types of dashboard reports which are available to readers, with the appropriate permissions, to access. The available dashboard reports which cover existing regulatory and statutory requirements, have been prepared for GTM by the leading industry experts in each field and encompass what leading organizations are currently using to manage their businesses effectively. Participating organizations may elect to make certain types of dashboard reports available to selected readerships. The availability of such a range of dashboard reports allows an organization which conventionally only had the ability to or access to existing regulatory reports to upgrade to dashboard reports for their data. It is also possible for leading organizations to be encouraged to sponsor new dashboard reports where they are market leaders.

The service marketplace module 50 also implements a marketplace for various services such as financial modelling. Readers and organizations have access to all financial modelling software which organizations acting as providers wish to make available. Historically, banks which have created innovative models have been reluctant to share their findings, not least because of the investment made. The server marketplace 50 provides a ready marketplace for such innovation by existing models providers but also by academics and banks themselves, together with model validation services. In one embodiment the service marketplace module 50 provides a list of all possible services which are available to a reader or organization at its website, and on selection of one of these options, the market place can route the reader or organization to a dedicated website where the service is provided. The advantage of this is that the proprietary algorithms do not need to be let out of the control of the proprietor but rather can simply be used by their parties for an appropriate fee. The results of the analysis would be provided via the website of the exchange system 26 and it is also possible for the performance dashboards described later to present the front end of such models enabling the reader to stress test data by adjustment of parameters and monitoring the results.

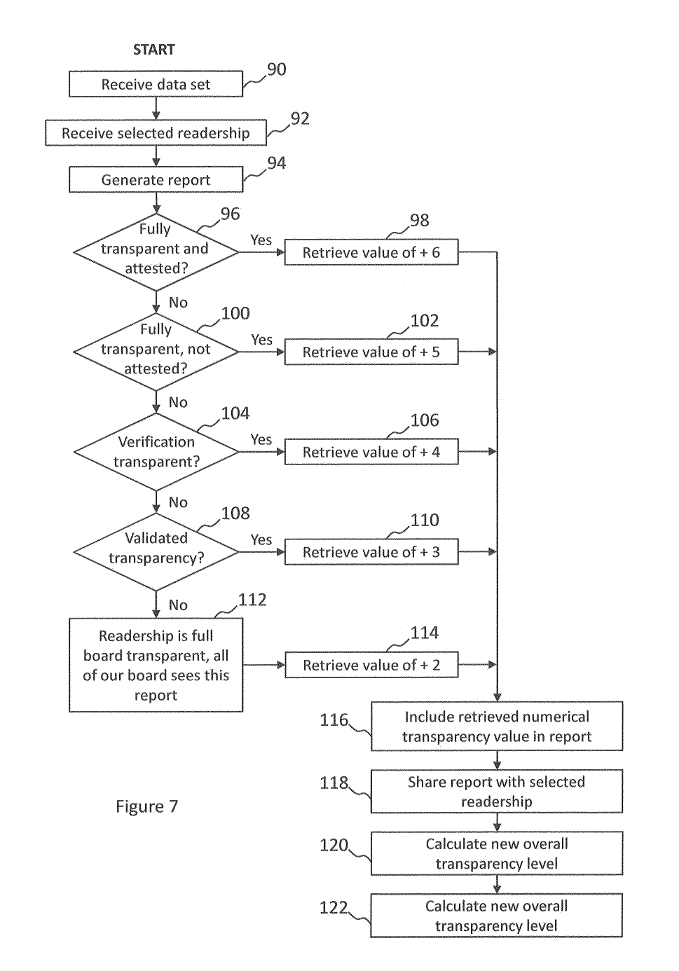

Having set out various systems and definitions, a method of sharing a dashboard report according to the present embodiment will now be described. This method is initiated by an organization uploading a new data set to the exchange system 26, and ends with the publishing of a new overall transparency level 152 of the organization. With reference to FIG. 7, the method starts by the communications server 38 of the exchange system 26 receiving at step 90 the new data set from the organization via its terminal 14, 16, 18. The organization also specifies the readership with which a resulting dashboard report is to be shared and the communications server 38 of the exchange system 26 receives at step 92 an indication of the selected readership. At this point, the data set for reporting has arrived in the exchange system 26 and is stored as part of the organization's profile 52 in in the exchange database 28 or is uploaded already processed for population of a given dashboard report. Of course, the data can now be processed and, as described above, the business intelligence module 44 of the processing module 40 reads the data stored in the exchange database 28 and process it to generate at step 94 a dashboard report.

The processing module 40 also processes the selected readership to determine a corresponding numerical transparency value 87. The transparency module 46 of the processing module 40 implements this step by referring to the look-up table 83 shown in FIG. 6. With reference to the look-up table 83, the transparency module 46 undertakes a series of decision steps to result in determining the numerical transparency value 87.

The transparency module 46 establishes at step 96 whether the readership is ‘Transparent to the public, fully attested and transparent’. If it is, the transparency module 46 retrieves at step 98 a corresponding numerical transparency value of 6 from the look-up table 83.

If it is not, the transparency module 46 establishes at step 100 whether the readership is ‘Transparent to the public, fully transparent but not attested’. If it is, the transparency module 46 retrieves at step 102 a numerical transparency value of 5 from the look-up table 83.

If it is not, the transparency module 46 establishes at step 104 whether the readership is ‘Verification transparent, attested by auditors and regulators’. If it is, the transparency module 46 retrieves at step 106 a numerical transparency value of 4 from the look-up table 83.

If it is not, the transparency module 46 establishes at step 108 whether the readership is ‘Verification transparency, attested and independently validated’. If it is, the transparency module 46 retrieves at step 110 a numerical transparency value of 3 from the look-up table 83.

If it is not, the transparency module 46 establishes at step 112 that the readership is ‘Full board transparent, all of our board sees this report’, and retrieves at step 114 a numerical transparency value of 2 from the look-up table 83.

Once the appropriate numerical transparency value 87 has been retrieved, the transparency module 46 stores the value in the exchange database as part of the organization's profile 52, and the value is included at step 116 in the dashboard report and the dashboard report is shared at step 118 with the selected readership. The organization now has a new dashboard report in its profile 52 together with an associated numerical transparency value 87. This means that the organization's overall transparency level 152 can be recalculated to take account of the new dashboard report. The transparency module calculates at step 120 a new overall transparency level 152 by taking an updated average of all the individual numerical transparency values 87 across all topics, at finally at step 122 the new overall transparency level 152 is published.

Aspects of the organization's profile which are always fully accessible by the public are: for each topic, the current numerical transparency value 87; and for the organization as a whole, the averaged overall transparency level 152. This public indication of the extent to which an organization is public provides an incentive to organizations to increase transparency across a wide range of topics. It will be appreciated that if an organization has previously provided a dashboard report 64 with a numerical transparency value 87 of ‘+4’, and subsequently the organization decides to restrict dashboard reports 64 on that topic to their full board, the numerical transparency value 87 associated with that topic will decrease to ‘+2’. As the overall transparency level 152 is an average of the current numerical transparency values 87 across all topics, the overall transparency level 152 will also be affected by a slight reduction.

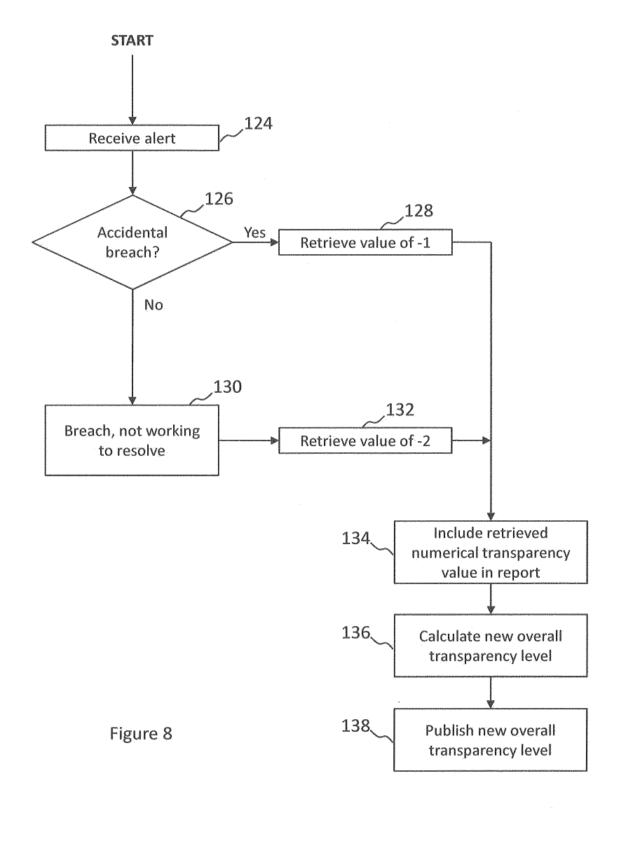

A method of providing accountability for misreporting according to the present embodiment will now be described. This method is initiated by a third party sending an alert to the exchange system 26 that an organization has reported misinformation. With reference to FIG. 8, the method 123 starts by the communications server 38 of the exchange system 26 receiving at step 124 an alert. The alert will either indicate or not indicate that the breach was an accident and that the organization is working to resolve it. In view of this, the transparency module 46 establishes at step 126 whether or not the alert indicates that there has been a GTM transparency breach, and that this was an accident and that the organization is working to resolve the breach. If it does, the transparency module 46 retrieves at step 128 a numerical transparency value of ‘−1’ from the look-up table 83. If the alert does not, the transparency module 46 establishes at step 130 that the alert indicates that there has been a GTM transparency breach, but that the organization is not working to resolve it, and retrieves at step 132 a numerical transparency value of ‘−2’ from the look-up table 83.

Once the appropriate numerical transparency value 87 has been retrieved, the transparency module 46 stores the value in the exchange database 28 as part of the organization's profile 52, and the value is included at step 134 in the dashboard report. The organization's overall transparency level 152 is recalculated at step 136 and published at step 138. This way, it is available for the general public to see which topic misinformation has been provided on, and whether the organization has provided this misinformation in error and is working to resolve the issue, or whether the organization is not working to resolve the issue and the misinformation has perhaps been provided knowingly.

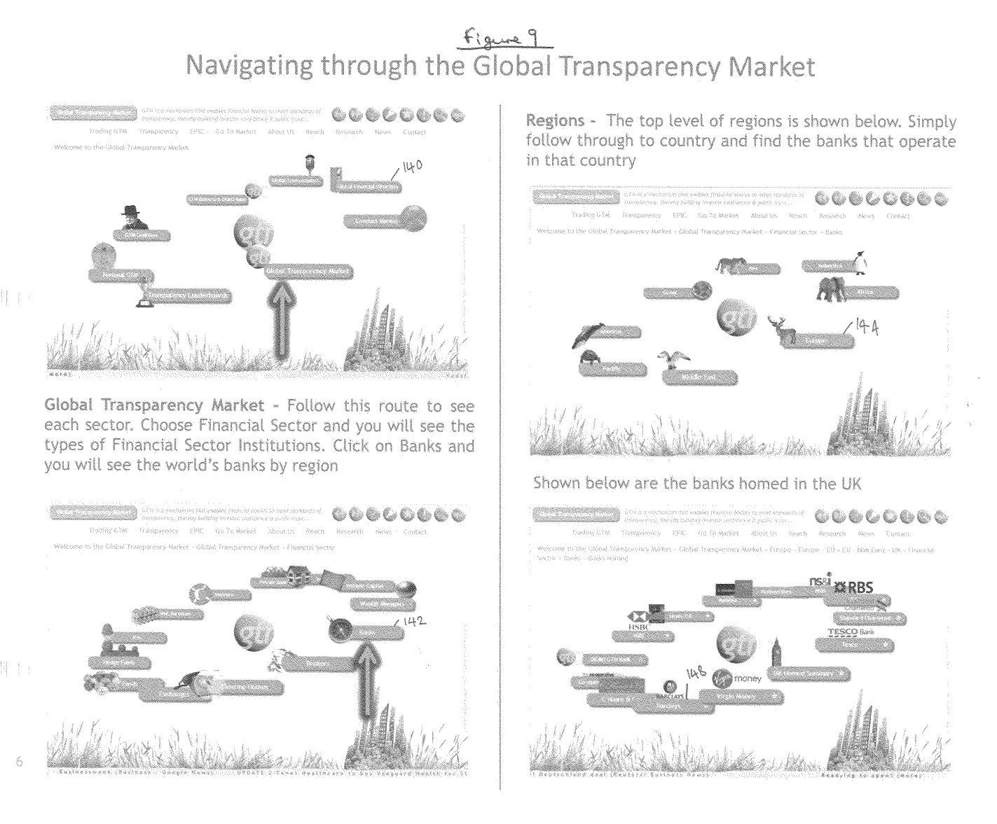

Log-in facilities and dashboard reports are provided to readers by the web server 42 of the exchange system 26 serving webpages. In order to retrieve a particular dashboard report, or even to view information relating to a specific organization of interest, a reader must first arrive at the homepage of the system (known, in this embodiment, as the Global Trust Market or GTM) and must navigate through the graphical user interface of the GTM to locate that particular organization. With reference to FIG. 9, four screenshots of the website are shown. The upper-left screenshot shows the homepage at which the reader starts. Navigation from this starting point will be described by way of an example in which the reader wishes to view information relating to risk management at the UK-based bank Barclays. It will be appreciated that all data provided in the example screenshots is artificial. In the homepage, and in all the layers of the menu structure, several icons are presented in a rotating ellipse around a central point on the screen. Icons enlarge as they come closer to the viewer and shrink as they move further away. This arrangement provides an inclusive, unbiased menu structure which presents the equivalent worthiness of each icon in turn by virtue of that icon arriving periodically at the front of the orbit and appearing in a larger size on the screen. User-friendly symbols and logos make the financial world more accessible to lay users. This has the benefit of not only presenting all of the selectable options to the reader but also ensuring that no one option is more likely to be selected than another. When the icons represent regions of the world or countries, the unbiased nature of the menu structure and the use of animal symbols and central bank logos rather than national flags has the benefit of presenting different territories in a politically neutral manner.

The reader wishing to see Barclay's information must first select the financial sector by clicking on the ‘Global Financial Directory’ icon 140 in the upper-left screenshot. The lower-left screenshot is then presented and the reader clicks on the ‘Banks’ icon 142. Banks are then organized in the menu structure by region, so the reader must click on the ‘Europe’ icon 144 in the upper-right screenshot and must then navigate further to the UK. UK banks are then presented as shown in the lower-right screenshot, and the reader clicks on the ‘Barclays’ icon 148.

Referring to FIG. 10, the reader is then presented with a screen showing a rotating ellipse menu of different categories on which Barclays may generate dashboard reports. The reader clicks on the ‘Manage Risk’ icon 150 and, referring to FIG. 11, is presented with a further menu of sub-categories relating to various management risk topics on which Barclays may generate a dashboard report. It can be seen from FIGS. 10 and 11 that in these screenshots, which are specific to the organization Barclays Bank, the overall transparency level 152 (also referred to as the Global Transparency Average, or GTA) for Barclays is indicated to four decimal places.

As shown in the top-right corner of, for example, FIGS. 10 and 11, there is a row of core buttons which aid the reader in his or her use of the GUI. Four main buttons are provided: a ‘help’ icon 154; a ‘key’ icon 156; a ‘favourites’ icon 160; and a ‘notification’ icon 166. Each of these is now described in turn. The ‘help’ icon 154 includes a question mark symbol and enables the reader to access definitions of financial and other terms and explanatory notes on aspects of reporting. When the reader clicks on the ‘help’ icon 154 a definitions and explanations sourced from a third party support information provider 30 such as Wikipedia®, are overlaid on the screen to aid the reader's understanding. An example of this is shown in FIG. 11a where it can be seen that a pop-up box 155 explaining the meaning of ‘Institutional Investors’ is presented on the GUI. This supports financial and other education of the readership and improves the intelligibility and therefore transparency of reporting to further readers.

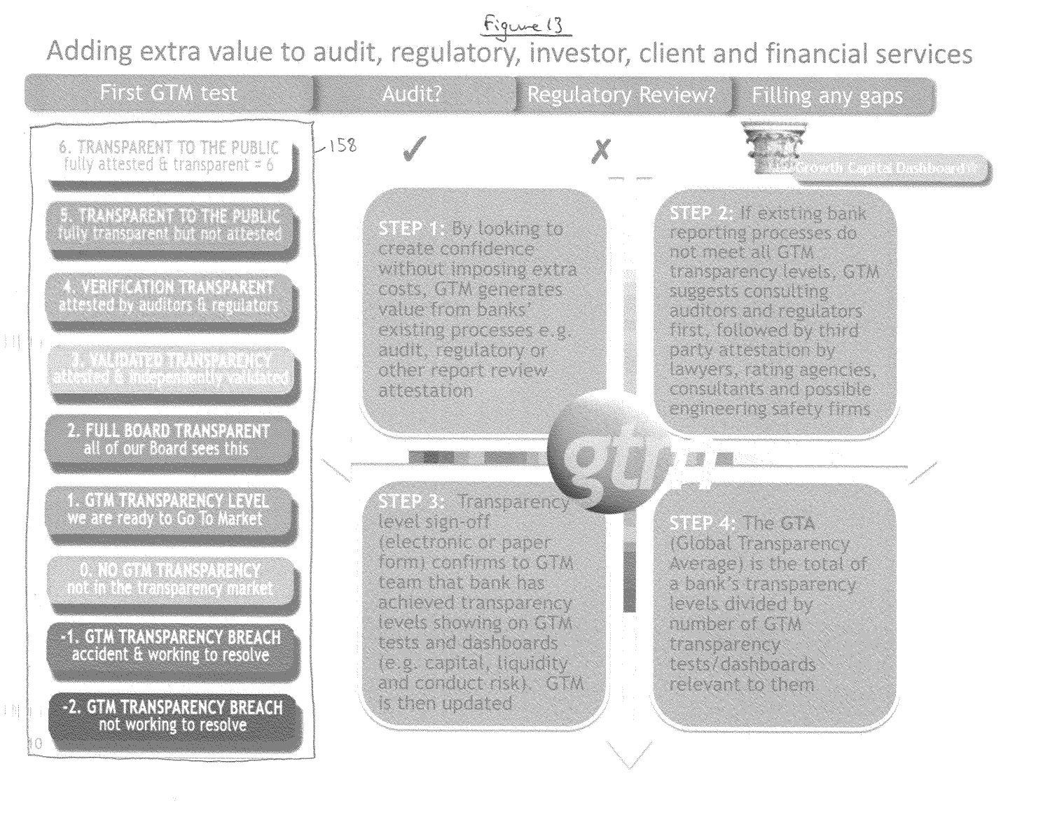

If the reader clicks the ‘key’ icon 156, a key display 158, as shown in FIG. 13, is overlaid on the screen. The key display 158 shows definitions of the readership types, in a hierarchy, together with the associated numerical transparency values as a quick reference tool for the user.

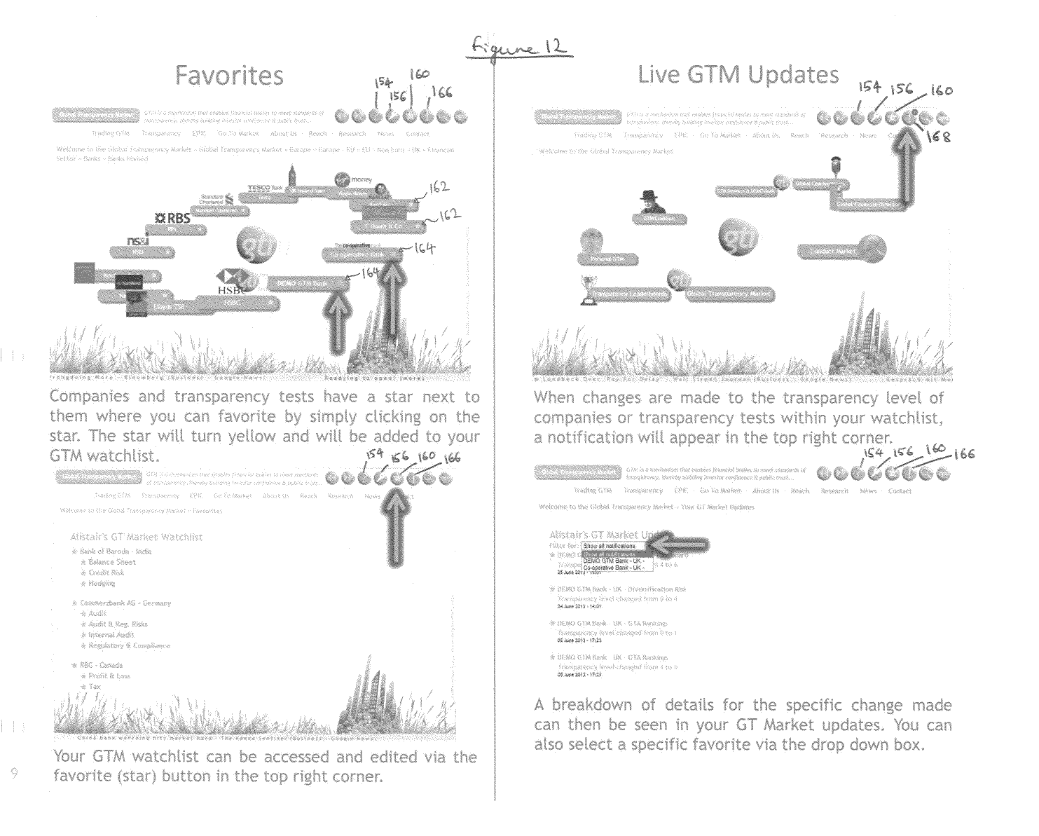

The ‘favourites’ icon 160 includes a start symbol and enables a reader to manage quick reference to organizations of particular interest. For example, referring to the upper-left screenshot of FIG. 12, each organization represented by an orbiting symbol has a small white star 162. If the user clicks on the small white star 162 it changes colour to become a small gold star 164, and the corresponding organization is added to a list of favourites for that user. Reporting categories or sub-categories may also be added to the list of favourites in this way, and the resulting list may be viewed by clicking on the favourites icon 160 to reveal a page, as shown in the example of the lower-left screenshot of FIG. 12.

The ‘notifications’ icon 166 comprising an exclamation mark symbol alerts a reader when there has been a change in the GTA of an organization in the reader's list of favourites. For example, if a single change has occurred to one of the favourite organizations, the reader is alerted to this by an adapted ‘alert’ icon 168 which includes a number ‘1’ in a small red circle, as shown in the upper-right screenshot of FIG. 12. By clicking on the adapted ‘alert’ icon 168 the reader can reach a webpage showing recent changes. An example is provided in the lower-right screenshot of FIG. 12 which shows that the numerical transparency value 87 of the Diversification Risk Report for DEMO GTM bank (a place-holding name for demonstration purposes only) has changed from ‘0’ to ‘+4’.

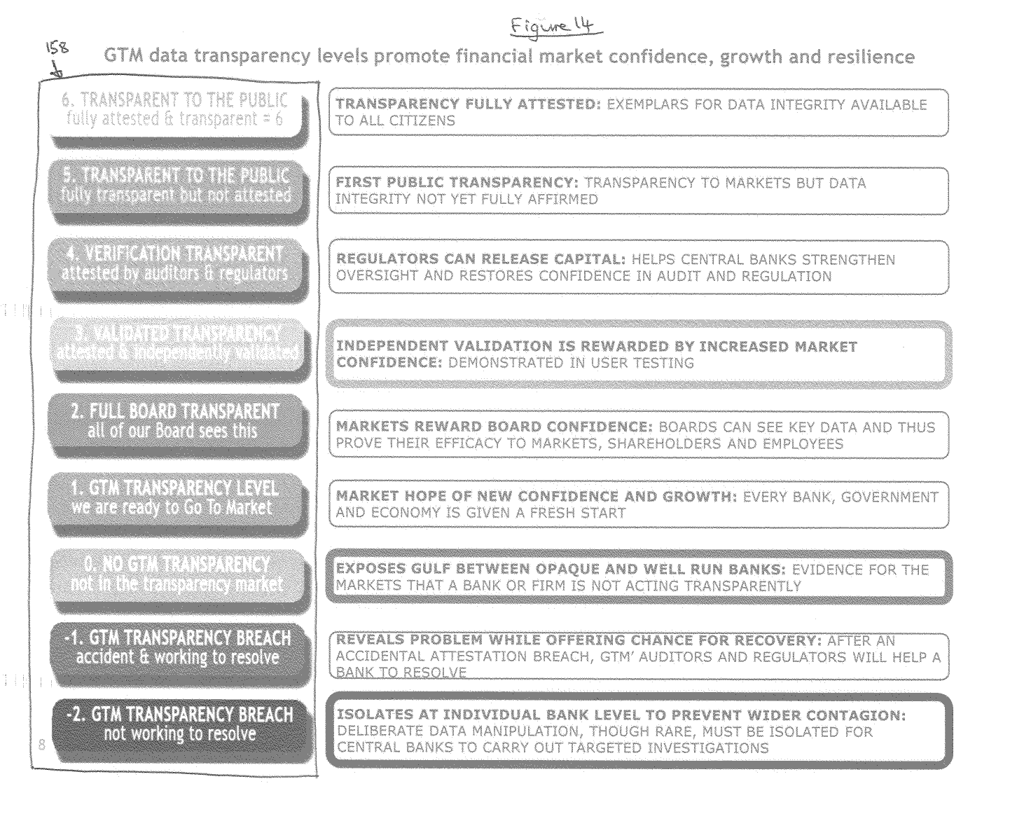

FIG. 13 includes the key display 158 introduced above. Various aspects of ensuring that the defined readerships and associated numerical transparency values are properly used and remain meaningful are indicated in the four steps outlined in FIG. 13. The key display 158 is repeated in FIG. 14 together with further statements relating to each of the readerships in the hierarchy.

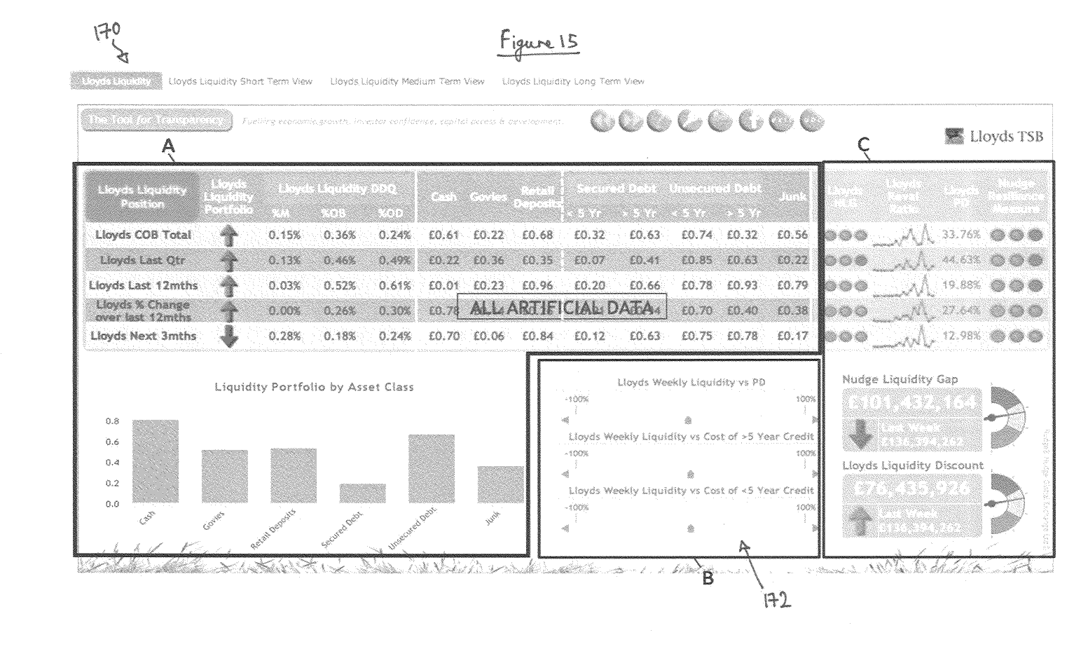

With reference to FIG. 15, a modelling dashboard report 170 presents processed organization data together with a range of sliders 172. These sliders 172 can enable a user to ask “what if” questions of the data. In other words, the GUI provides a front end to access a financial data model for which several variable parameters are linked to the sliders 172. More specifically, a dashboard report presentation part of the GUI, A, sits next to a user-interaction part of the GUI, B. The sliders 172 in the user interaction part, B, are used to set user variables which are used by prediction models (not shown but which can be proprietary algorithms for determining summary values reflecting an industry comparable benchmark) to determine output results which are also displayed in a predictions part of the GUI, C (on a single page of the GUI in this embodiment). For example, the middle slider 172 on FIG. 15 enables the user to change the possible future cost of more than five years' credit, and see what impact this would have on the financial health of the organization. The predicted impact of the user selected cost are then displayed in the right-most section of the screenshot in FIG. 15 so that the user can readily see the impact of the potential future financial conditions, thereby stress testing the organization for financial robustness against potential changes in the wider economic environment.

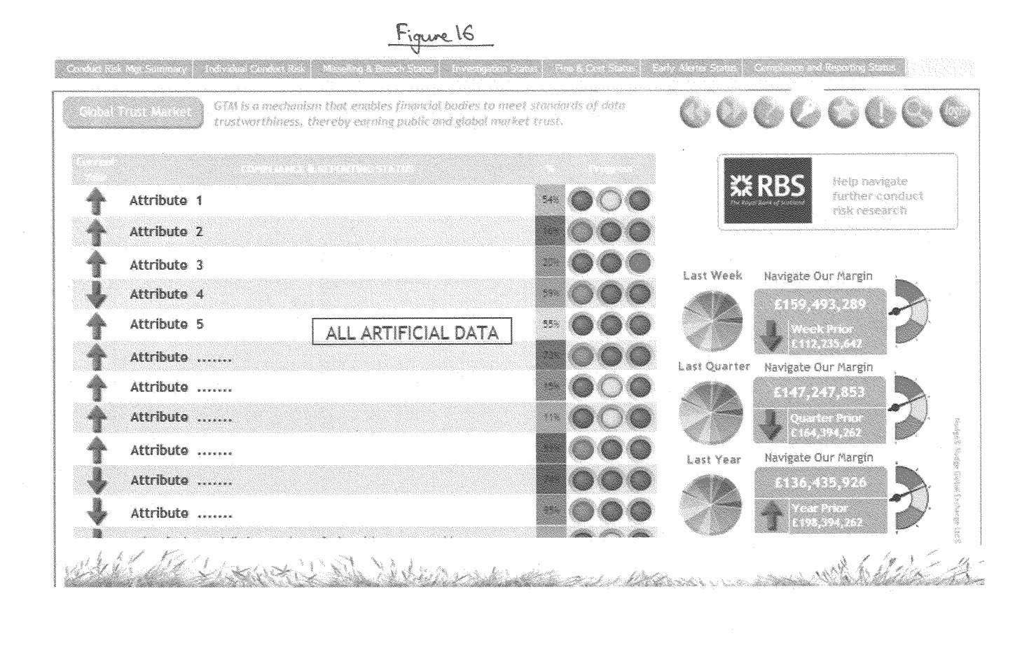

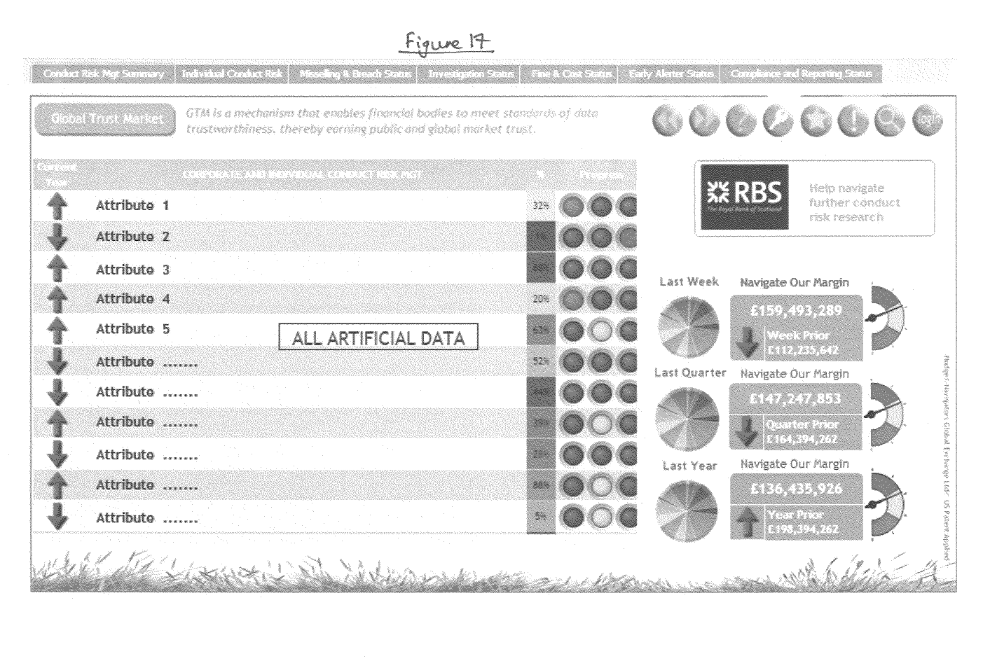

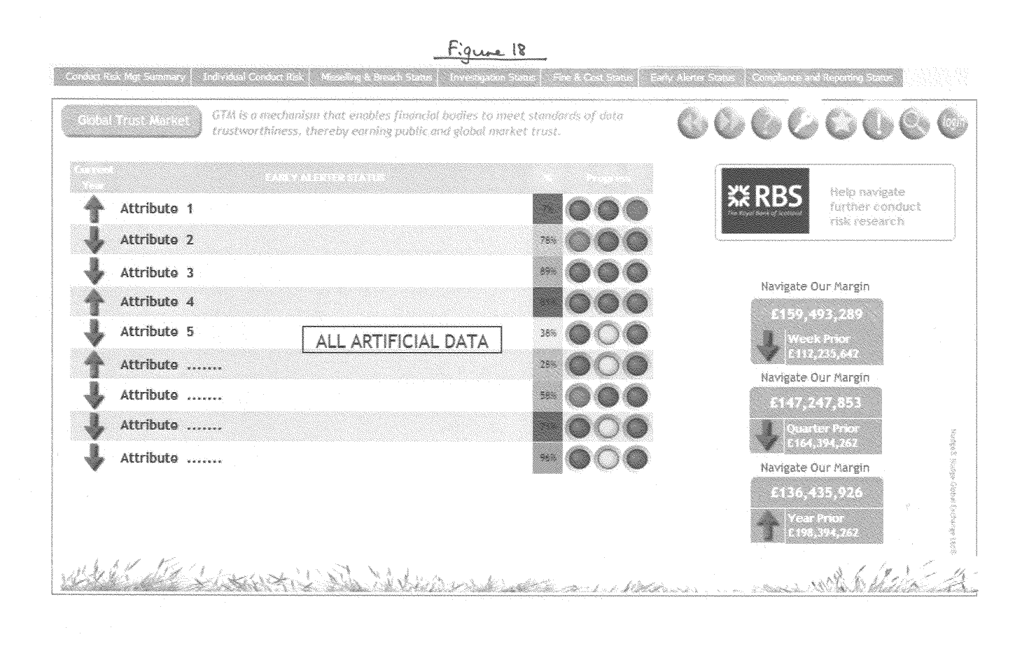

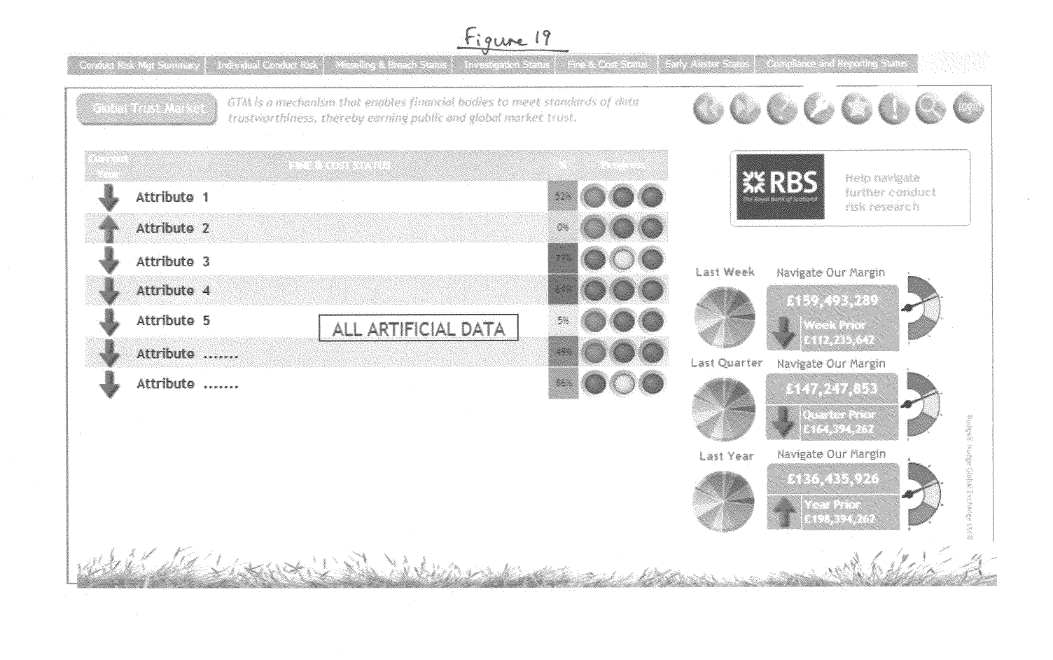

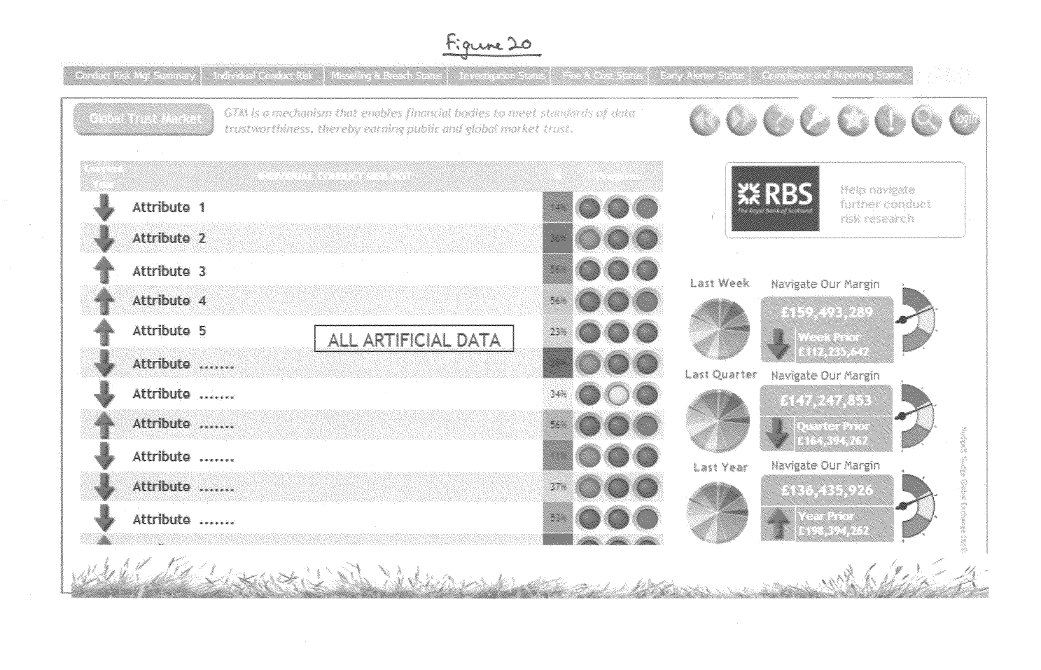

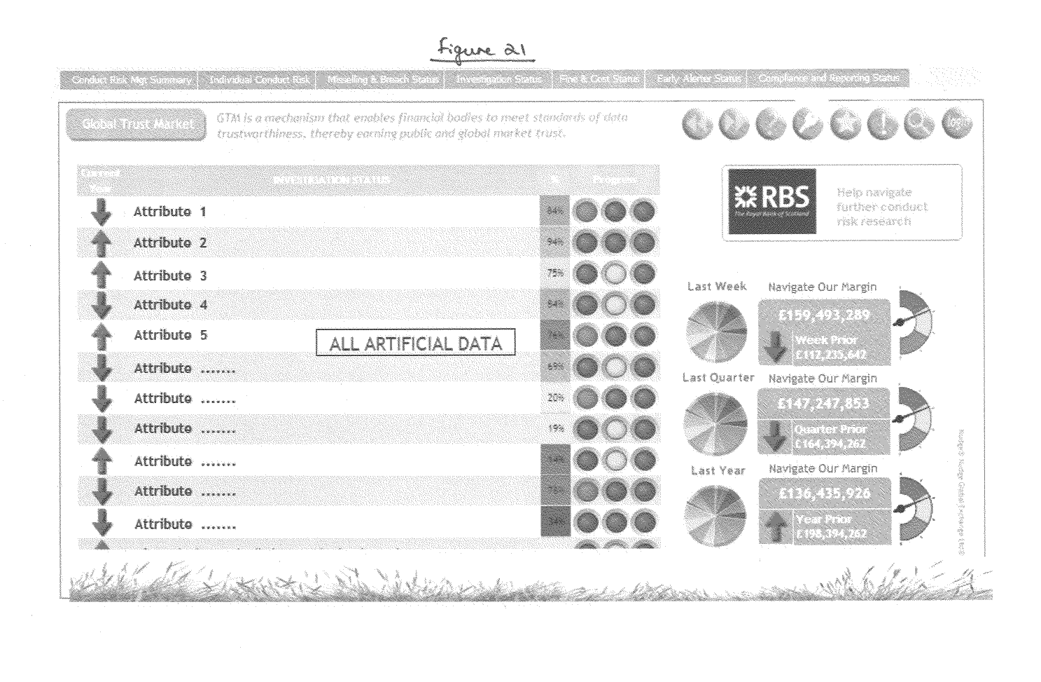

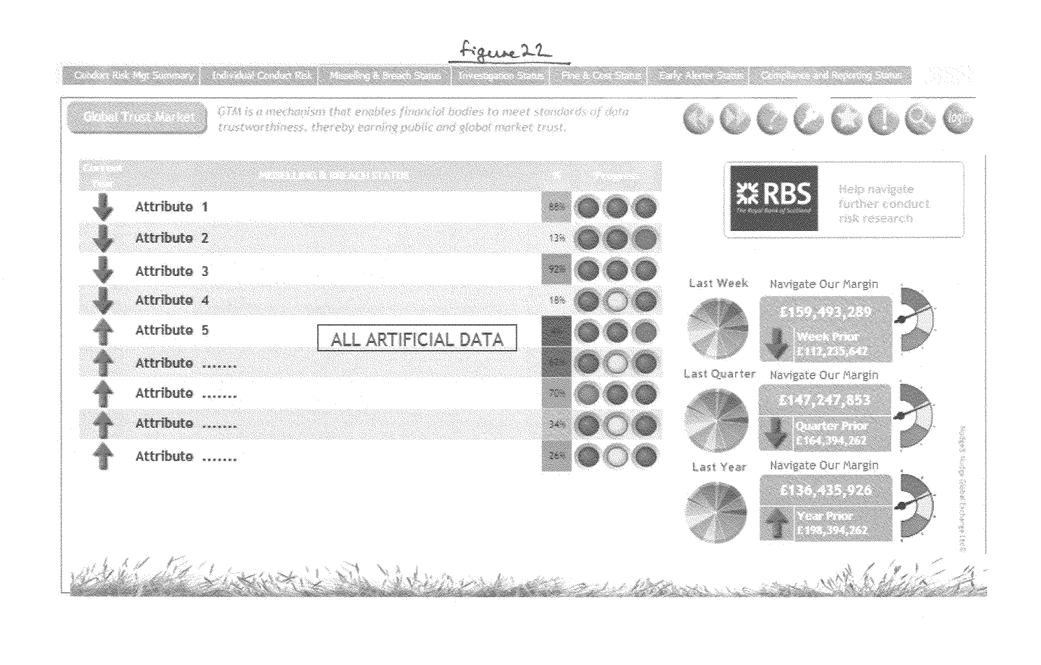

With reference to FIGS. 16 to 22, a process has been created which uniquely covers all aspects of the culture of a company from stated values and expectations of conduct at the corporate and the individual level. This allows not only assessment of the outcomes of the more common aspects such as policies towards customers, staff (including family friendly and people inclusive dashboards covering diversity), suppliers and other stakeholders, but ultimately allows an assessment of how well managed a company is. At the corporate level, the dashboard data ranges from the impact of non-compliance with regulatory requirements to the corporate approach to “whistleblowing”. The process of assessment of culture and conduct at the level of the individual is unique to GTM in that it recognises the massive impact of the behaviour of certain “sociopathic” individuals on the culture of a company particularly when they are in positions of power. This includes references to the traits and “tells” of the behaviours of these individuals to help with their identification on a subjective basis but also allows for an objective quantification of their impact in monetary terms.

The GTM architecture which supports the GTM has been very specifically designed to address potential issues and concerns surrounding cybersecurity. Whilst the process leads to full transparency as institutions increase their transparency as they progress through the levels over time, security of data up to the point that it becomes transparent to the outside world is critical. Data may be collated within a bank up to level 4 without display on the GTM portal. This means that the underlying data stays within the bank and is not accessible from the portal. Where bank data is collated up to country level (for information for a country's regulators and government for economic analysis purposes), the data may still be housed and collated within a country and comply with that country's own cybersecurity parameters.

For example, the UK may warehouse and collate data for UK banks on UK servers which are subject to UK cybersecurity protocols. Data may be viewable at the UK aggregated country level (although not at the individual bank level) via the GTM if the UK so chooses but again the underlying data will be kept entirely separate and will not be accessible from the GTM.

In respect of data held and viewable from the portal (levels 5 and 6), under its own data management policy, GTM itself prioritises US cybersecurity policies as a minimum standard and means to continue this policy working with the world's US-led cyber security groups. GTM will flex and adapt its data management policies to suit US requirements as they evolve.

In an alternative embodiment it would be possible for the organization terminal to send a copy of a dashboard report which has already been generated to the exchange system 26 rather than have the dashboard report generated by the system 26 itself.

The present embodiments provide a simple infrastructure for publishing data which promotes convergence on best practice in management and reporting (of capital, liquidity and risk). This standardisation of reporting in turn enables and promotes macroeconomic analysis. Currently organizations report in their own way which may be anything from poor to best in class. By providing the same business intelligence tools (modelling and report generation tools for example) and the same templates for organizations to upload data to and use to generate dashboard reports, the whole process becomes standardised and improved. The present embodiments can produce specific financial dashboard reports directed to liquidity and capital which can identify the gap between an organization's current levels and the required level in both of these areas. The present embodiment allows for the easy addition of new dashboard reports to the library of existing dashboard reports as industry best practice moves forward.

The present embodiments also provide synchronicity of oversight to boards, auditors, regulators, ratings agencies, investors and the public. Published data becomes mass verifiable. Also the present embodiments enable recognition of conduct risk (poor behaviour by certain individuals, circumventing rules and ignoring risk warnings) and transparency as a tool for limiting the impact of conduct risk and promoting ethical behaviour. One of the benefits of transparency is that it provides access to cheaper funding, it can reduce capital and collateral requirements, differentiate share price, and circumvent the activity of short-stalking based on inaccurate rumour. Also transparency provided by the present embodiments enables governments to predict and circumvent asset bubbles, restore public trust in organizations, and also to respond to the “shareholder spring” movement's demand for more control over boardroom pay.

The graphical user interface used in the present embodiments, provides a revolving ellipse of menu options. This provides an inclusive, depoliticised menu/listing structure; where click through via orbiting symbols to other pages is possible. In one embodiment options can include financial institutions by region and by type. Each symbol is a node in a hierarchical navigation structure of the GUI. The symbols enlarge as they appear to come closer to the viewer and shrink as they appear to move further away during movement through the elliptical path of the GUI. This provides efficiency of use of the display as only some of the symbols are displayed in a large size at any one time, and also the worthiness of each item is demonstrated in a repeating sequence so that they are treated equally and each one has the same importance. The present GUI uses symbols and logos to make the financial world more accessible to lay users and makes the symbols easier to recognise when they have orbited away and are smaller.

Given the standardised nature of the data which is collated for each dashboard report, data aggregation is facilitated enabling the creation of useful data at a variety of levels. A financial institution may wish to aggregate the data in a given dashboard report from individual branch or regional dashboard reports. A country regulator may wish to aggregate the dashboard reports of all organizations for which they have worldwide supervisory responsibility. A national government may wish to aggregate the dashboard reports of all banks operating within its national boundaries. Indeed, a country may wish to make certain dashboard reports fully transparent at the aggregated country level but this would not necessarily mean that the individual component organizations would also need to be fully transparent. A supranational organization may wish to collate the data of several countries e.g., the European Union for countries using the Euro or all EU countries. The present embodiment therefore facilitates the earlier publishing of data for macroeconomic analysis, whilst maintaining the anonymity of constituent organizations if so wished given the nature of the reporting on a geographical basis, countries may choose to disclose economic data relevant to a whole country at the country level which may not be applicable at the bank or organization level. Examples are economic indicators such as inflation management, growth and velocity and national registers such as land registries. Supranational organizations can collate country data to track global figures in respect of important measures such as the UN and their Millennium Development Goals, using the same processes described above. The provision of pop-up or hover boxes which explain the meanings of terms (help style functionality) improves transparency and financial literacy.

It is possible in some embodiments to upload data by (1) a flat file using agreed data transfer standards, (2) a data slotting mechanism or (3) live interface (auditors or regulators only, not public because of data security and bank customer confidentiality, allows auditors and regulators to stress test data). Data is typically uploaded into a data cloud which underlies the exchange system (portal). However, underlying transactional data need not be uploaded as this would likely be too much data to process. It is not an aim of the present embodiments to circumvent existing systems and development.

Embodiments of the invention may be applied to reporting not only of financial data but also of data relating to many other fields, for example pharmaceuticals, medical research, education, defence, culture, construction, charity, agriculture, manufacturing, mining and fuels, real estate, retailing, conservation, sustainables, transport, tourism, utilities, technology and land registry.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

In certain embodiments, the acts, methods, and processes described herein are implemented within, or using, software modules (programs) that are executed by one or more general purpose computers. The software modules may be stored on or within any suitable computer-readable medium. It should be understood that the various steps may alternatively be implemented in-whole or in-part within specially designed hardware. The skilled artisan will recognize that not all calculations, analyses and/or optimization require the use of computers, though any of the above-described methods, calculations or analyses can be facilitated through the use of computers.

Although the foregoing systems and methods have been described in terms of certain preferred embodiments, other embodiments will be apparent to those of ordinary skill in the art from the disclosure herein. Additionally, other combinations, omissions, substitutions and modifications will be apparent in view of the disclosure herein. While certain embodiments of the inventions have been described, these embodiments have been presented by way of example only, and are not intended to limit the scope of the inventions. Indeed, the novel methods and systems described herein may be embodied in a variety of other forms without departing from the spirit thereof. Further, the disclosure herein of any particular feature, aspect, method, property, characteristic, quality, attribute, element, or the like in connection with an embodiment can be used in all other embodiments set forth herein. Accordingly, other combinations, omissions, substitutions and modifications will be apparent in view of the disclosure herein.

What is claimed is:

1. A method of demonstrating organizational transparency, the method including:
defining a plurality of different groups of readers to whom organizations may elect to make a report available, wherein each group of readers has an associated transparency value;
receiving a report which has an associated group of readers;
calculating a transparency level of an organization by determining the transparency value of the associated group of readers to whom the report has been made available; and
publishing the calculated transparency level of the organization.

2. The method of claim 1, further including defining a list of topics on which organizations may voluntarily provide data for a report; and wherein the calculating step comprises considering how many topics from the list of topics have been reported on.

3. The method of claim 2, wherein the calculating step comprises reading a current transparency value for each topic and calculating the overall transparency level as an average of the current transparency values for all topics.

4. The method of claim 3, further including assigning a default transparency value to any topic of the list of topics for which a report has not been received.

5. The method of claim 3, further including determining whether a received report is based on incorrect data and if so assigning a first corresponding transparency value to a report which is determined to be based on incorrect data.

6. The method of claim 5, wherein the determining step comprises determining whether the organization is working to correct the incorrect data and the assigning step comprises assigning a second corresponding transparency value to the report.

7. The method of claim 6, wherein the assigned transparency value is negative.

8. The method of claim 7, wherein the determining step comprises receiving an alert from a third party indicating the incorrectness of a published report.

9. The method of claim 3, wherein the transparency value has a value in a range extending from positive numbers to negative numbers.

10. The method of claim 9, wherein the range extends from +6 to −2, with a value of +6 associated with full transparency to the public and a value of −2 associated with no transparency.

11. The method of claim 1, wherein each group of readers is organized in a hierarchical series, with each adjacent group of readers in the series comprising a subset of an adjacent group.

12. The method of claim 1, wherein the receiving step comprises presenting a list of the plurality of different groups of readers and receiving a selection of a particular group of readers which is to be associated with the report.

13. The method of claim 1, wherein the receiving step comprises receiving data regarding the organization and generating the report from the received data.

14. The method of claim 13, wherein generating the report includes providing the calculated transparency value for the report in the report.

15. The method of claim 14, wherein the publishing step comprises publishing the generated report to the group of readers associated with the report.

16. The method of claim 1, further including publishing the report to its associated group of readers.

17. The method of claim 16, further including creating a set of permissions associated with a report and the publishing step further comprises checking the permissions of a reader and only publishing the report to a reader who is permitted to access the report.

18. The method of claim 1, wherein the publishing step comprises providing a directory of organizations and publishing the calculated transparency level of each organization in the directory.

19. The method of claim 18, further including providing a website through which each organization can be selected and reports relating to that organization can be provided.

20. The method of claim 19, further comprising providing market place for accessing services related to modelling data.

21. The method of claim 20, further including providing a GUI with a dashboard for enabling stress testing of data using a model provided by the selected modelling service.

22. A system for demonstrating organizational transparency, the system comprising:
a processor provided within the system which is configured to:
use a stored definition of a plurality of different groups of readers to whom organizations may elect to make a report available, wherein each group of readers has an associated transparency value;
receive a report which has an associated group of readers;
calculate a transparency level of an organization by determining the transparency value of the associated group of readers to whom the report has been made available; and
publish the calculated transparency level of the organization.

23. A system for demonstrating organizational transparency, the system comprising:
a database storing a definition of a plurality of different groups of readers to whom organizations may elect to make a report available, wherein each group of readers has an associated transparency value;
a transparency module for receiving a report which has an associated group of readers; the transparency module having a processor configured to calculate a transparency level of an organization by determining the transparency value of the associated group of readers to whom the report has been made available; and
a server for publishing the calculated transparency level of the organization.

24. A computer-implemented method of demonstrating organizational transparency, the method including:
defining a list of topics on which organizations may voluntarily provide data for creating a report;
defining a series of readerships to which organizations may elect to make such a report available, wherein each successive readership in the series includes a further class of readers;
calculating an overall transparency level of an organization by taking into account how many topics from the list have been reported on and to which readership each report has been made available; and
publishing the overall transparency level of the organization.

25. A method according to claim 1, wherein the report is a dashboard report.

26. The method of claim 5, wherein the assigned transparency value is negative.

27. The method of claim 26, wherein the determining step comprises receiving an alert from a third party indicating the incorrectness of a published report.
